(19) United States
(12) Patent Application Publication
(10) Pub. No.: US 2026/0103929 A1
(43) Pub. Date: Apr. 16, 2026

(54) SHOWER DOOR ASSEMBLY

(71) Applicant: KOHLER CO., Kohler, WI (US)

(72) Inventors: Mark Andrew LISTER, Martin, TN (US); Aleksandra Alexandrovna IRVING, Dyersburg, TN (US); Luke Benjamin ZIMBRIC, Saukville, WI (US); Jacob Levi DULMES, Belgium, WI (US); James Gerard SWENDSON, Kohler, WI (US)

(73) Assignee: KOHLER CO., Kohler, WI (US)

(21) Appl. No.: 19/352,062

(22) Filed: Oct. 7, 2025

Related U.S. Application Data
(60) Provisional application No. 63/705,757, filed on Oct. 10, 2024.

(51) Int. Cl. E05D 15/06; A47K 3/34

(52) U.S. Cl. CPC E05D 15/0652; A47K 3/34; E05Y 2600/452; E05Y 2600/52

(57) ABSTRACT

A shower door assembly can include a header that can support a door. The shower door assembly can include a shower wall having a cutout that can receive a portion of the header. The shower door assembly can include a drop-in locking piece that can be disposed in the cutout to fix the portion of the header to the shower wall.

### CROSS-REFERENCE TO RELATED PATENT APPLICATIONS

This application claims the benefit of and priority to U.S. Provisional Application No. 63/705,757, filed Oct. 10, 2024, the entire disclosure of which is hereby incorporated by reference herein.

### BACKGROUND

The present disclosure relates generally to a shower door assembly. More specifically, the present disclosure relates to a shower door assembly having walls with a space that can receive a header to fix the header to the wall.

In some instances, the installation of various types of shower doors, such as sliding shower doors, can be time-consuming and often involves the use of various brackets, fasteners, multiple cuts of aluminum or stainless steel extrusions, or other components. Additionally, in some instances, after a shower door is installed, the door may move out of position for various reasons. Thus, it would be advantageous to provide a shower door assembly that addresses one or more of the aforementioned issues.

### SUMMARY

At least one aspect of the present disclosure relates to a shower door assembly. The shower door assembly can include a header that can support a door. The shower door assembly can include a shower wall having a cutout that can receive a portion of the header. The shower door assembly can include a drop-in locking piece that can be disposed in the cutout to fix the portion of the header to the shower wall.

At least one aspect of the present disclosure relates to a shower system. The shower system can include a door. The shower system can include a header that can support the door such that the door can move relative to the header. The shower system can include a shower wall having a cutout that can receive a portion of the header. The shower system can include a drop-in locking piece that can be disposed in the cutout to fix the portion of the header to the shower wall. The shower system can include a shower floor having at least two guides that can guide movement of the door relative to the floor and the header.

At least one aspect of the present disclosure relates to a method of installing a shower door assembly. The method can include receiving, by a first section of a cutout of a shower wall, a portion of a header. The header can support a door. The method can include receiving, by a second section of the cutout, the portion of the header responsive to the header moving in a first direction. The method can include fixing the portion of the header in the second section of the cutout by receiving, by the first section of the cutout, a locking piece. The first section of the cutout can be disposed adjacent to the second section of the cutout.

### BRIEF DESCRIPTION OF THE DRAWINGS

FIG. 1 is a perspective view of a shower system, according to an example embodiment.

FIG. 2 is a perspective view of a shower door assembly of the shower system of FIG. 1 in a first state, according to an example embodiment.

FIG. 3 is a perspective view of the shower door assembly of FIG. 2 in a second state, according to an example embodiment.

FIG. 4 is a perspective view of the shower door assembly of FIG. 2 in a third state, according to an example embodiment.

FIG. 5 is a perspective view of the shower door assembly of FIG. 2 in a fourth state, according to an example embodiment.

FIG. 6 is a perspective view of the shower door assembly of FIG. 2 in a fifth state, according to an example embodiment.

FIG. 7 is a perspective view of a shower door assembly of the shower system of FIG. 1 in a first state, according to an example embodiment.

FIG. 8 is a perspective view of the shower door assembly of FIG. 7 in a second state, according to an example embodiment.

FIG. 9 is a perspective view of the shower door assembly of FIG. 7 in a third state, according to an example embodiment.

FIG. 10 is a perspective view of the shower door assembly of FIG. 7 in a fourth state, according to an example embodiment.

FIG. 11 is a perspective view of the shower door assembly of FIG. 7 in a fifth state, according to an example embodiment.

FIG. 12 is a perspective view of the shower door assembly of FIG. 7 in a sixth state, according to an example embodiment.

FIG. 13 is a perspective view of the shower door assembly of FIG. 7 in a seventh state, according to an example embodiment.

FIG. 14 is a perspective view of a portion of the shower door assembly of FIGS. 2 and 7, according to an example embodiment.

FIG. 15 is a perspective view of the shower system of FIG. 1 with a portion of the shower door assembly removed, according to an example embodiment.

FIG. 16 is another perspective view of the shower system of FIG. 1, according to an example embodiment.

FIG. 17 is another perspective view of the shower system of FIG. 1, according to an example embodiment.

FIG. 18 is an illustration of a process of installing the shower door assembly of FIGS. 2 and 7, according to an example embodiment.

### DETAILED DESCRIPTION

Referring generally to the FIGURES, disclosed herein is a shower door assembly that allows for easy installment of a header while minimizing or eliminating the use of brackets and/or fasteners. The shower door assembly can include a header that can support a door. The shower door assembly can include at least one shower wall having a cutout that has a first section that can receive at least a portion of the header. The cutout has a second section that can receive the header responsive to the header moving in a direction towards the second section. The first section of the cutout can receive a locking piece that can fix the header within the second section of the cutout. The second section of the cutout can be disposed away from an edge of the shower wall such that the shower wall, in combination with the locking piece, surrounds or encloses at least a portion of the header on all sides of the header. Such configuration maintains the header in position within the shower wall without the use of a bracket, allowing for a simple and fast installation of the header and shower door as compared to conventional techniques. One or more portions of the shower door assembly, such as the cutout, can be or can include a molded drop-in component that can removably couple to the shower wall such that the cutout is interchangeable for variously sized and/or shaped headers.

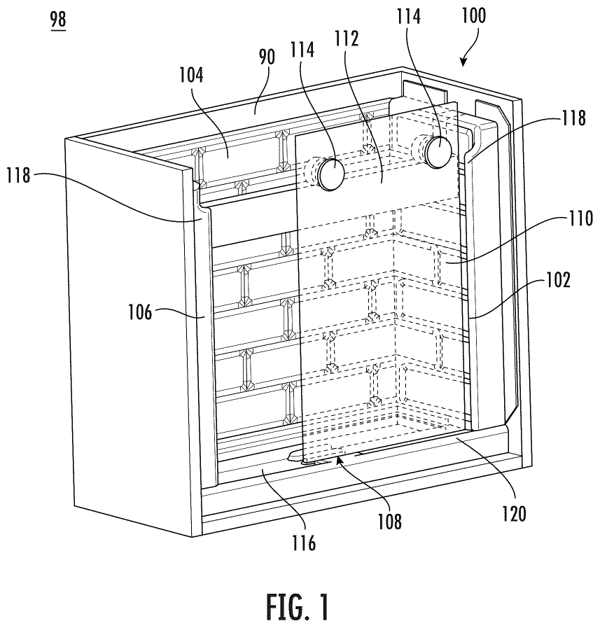

FIG. 1 depicts a perspective view of a shower system 98. The shower system 98 can include various bathing components that facilitate forming the shower system 98 including, but not limited to, a showerhead connected to a water supply, a drain, and/or a door 110. The door 110 can include various types of door hinges or other components. For example, the door 110 can include a sliding door (e.g., a sliding glass door). The shower system 98 can include a shower door assembly 100 that facilitates coupling the door 110 to the shower system 98. For example, the shower door assembly 100 can facilitate coupling the door 110 with one or more walls of the shower system 98.

The shower system 98 can include a first shower wall 102, a second shower wall 104, and a third shower wall 106. The shower walls 102, 104, 106 can couple with the door 110 to form an enclosure for the shower system 98. The shower walls 102, 104, 106 can couple to one or more portions of a shower environment 90, such as one or more surfaces of a bathroom. The shower system 98 can include at least one header 112. The header 112 can include one or more rods (e.g., shower curtain rod), bars, frames, poles, or other similar components capable of coupling the door 110 and/or another door-like component (e.g., curtain) with the shower system 98. The header 112 can extend across of a top area of the shower system 98 (e.g., between the first shower wall 102 and the opposing third shower wall 106). The header 112 can receive one or more rollers 114 that can couple the door 110 to the header 112 such that the door 110 can slide relative to the header 112. The shower system 98 can include a shower floor 116. The shower floor 116 can include at least one guide 108 (e.g., lip) to facilitate guiding the sliding of the door 110 relative to the shower floor 116. The shower system 98 can include one or more built-in wall jambs. For example, the shower system 98 can include one or more side wall jambs 118 that can at least partially protrude from one or more walls 102, 106 of the shower system 98 to support the door 110 and/or facilitate with water containment within the shower system 98. The shower system 98 can include one or more floor jambs 120 (e.g., partially raised walls or barriers) that can at least partially protrude from the floor 116 of the shower system 98 to support the door 110 and/or facilitate with water containment within the shower system 98.

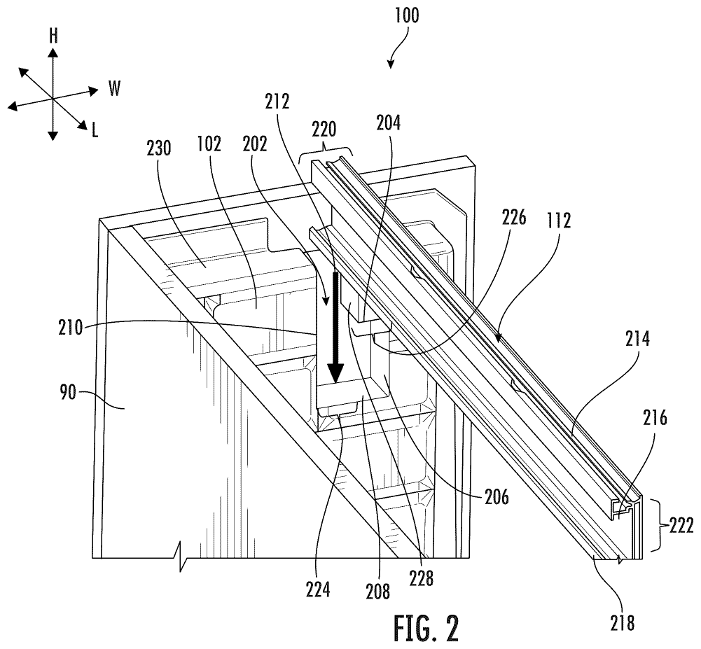

FIG. 2 depicts a perspective view of the shower door assembly 100, according to an example embodiment. FIG. 2 depicts the shower door assembly 100 in a first state in which a portion of the shower door assembly 100 can receive a portion of the header 112. For example, at least one of the shower walls (e.g., the first wall 102 and the third wall 106) can include a cutout 202 configured to receive a portion of the header 112. It should be understood that while the cutout 202 and process of installing the header 112 is shown and described with reference to the first wall 102, the third wall 106 and/or another wall of the shower system 98 may include an identical or similar configuration.

The cutout 202 can be defined by one or more surfaces of the shower wall 102 including, but not limited to, a first surface 204, a second surface 206, a third surface 208, a fourth surface 210, and a fifth surface 228. The cutout 202 can be formed directly within the shower walls 102, 106, or the cutout 202 can be formed into a separate piece (e.g., a molded drop-in component), as described in greater detail herein. The cutout 202 can include a first section 224 and a second section 226 (e.g., extending in the W direction). The first section 224 and/or the second section 226 can include a first width (e.g., in the W direction) that is about equal to or greater than a width 220 of the header 112. For example, the first surface 204 can extend into the cutout 202 to define the second section 226. The first section 224 and the second section 226 can differ in height (e.g., in the H direction). For example, the first section 224 can extend about the same height as the fourth surface 210 of the cutout 202. The second section 226 can extend about the same height as the second surface 206 of the cutout 202.

The second section 226 can include a height large enough to receive the entire height 222 of the header 112. In some examples, the height of the second section 226 may be about equal to or slightly greater than the height 222 of the header 112. The second section 226 can define or include a pocket of the cutout 202 configured to receive and at least partially enclose a portion of the header 112 to fix the header 112 relative to the second section 226 in at least two directions. The second section 226 can be defined by the first surface 204 of the cutout 202, the second surface 206, and a portion of the third surface 208 that extends substantially the width of the first surface 204. The first section 224 of the cutout 202 can be defined by the fourth surface 210 of the cutout 202, the fifth surface of the cutout 202, and the portion of the third surface 208 that does not extend substantially the width of the first surface 204.

The first section 224 of the cutout 202 can include at least one opening that extends through an edge 230 or topmost section of the shower wall 102 to receive the header 112. The second section 226 may not include an opening that extends through the edge 230 or topmost section of the shower wall 102 (e.g., the second section 226 is disposed away from the edge 230 of the shower wall 102 such that, when the header 112 is disposed within the second section 226 as described herein, moving the header 112 in a height (H) direction will not cause the header 112 to be displaced from the cutout 202.

In the first state shown in FIG. 2, the cutout 202 can receive at least a portion of the header 112 (e.g., when the header 112 is moved in the direction of arrow 212). In some implementations, the header 112 can include a top rail 214, a bottom rail 218, and an open space 216 between the top and bottom rails 214, 218 to facilitate receiving the door 110 and slidably coupling the door 110 to the shower system 98.

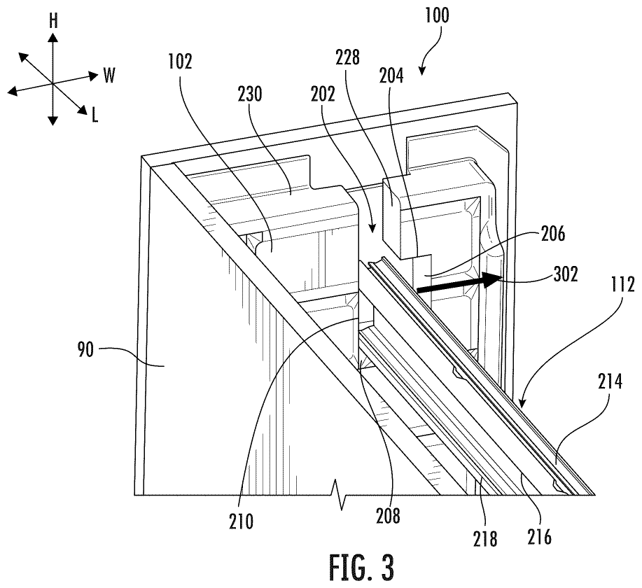

FIG. 3 depicts a perspective view of the shower door assembly 100, according to an example embodiment, in a second state in which the first section 224 of the cutout 202 receives a portion of the header 112. As depicted in FIG. 3, the first section 224 (FIG. 2) of the cutout 202 can receive the header 112 such that a topmost section of the header 112 (e.g., in the H direction) is disposed beneath a plane running parallel with the first surface 204 of the cutout 202 and a bottommost section of the header 112 contacts or engages with the third surface 208 of the cutout 202. The header 112 can slide in the direction of arrow 302 to the second section 226 (FIG. 2) of the cutout to at least partially fix the header 112 within the cutout 202.

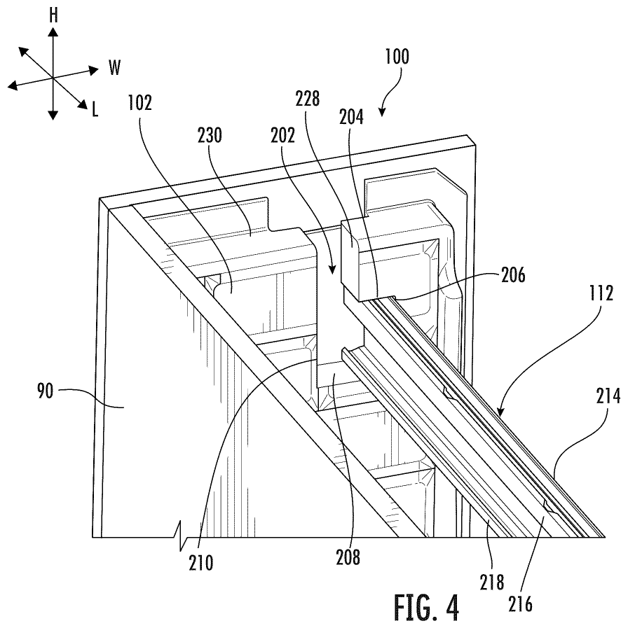

FIG. 4 depicts a perspective view of the shower door assembly 100, according to an example embodiment, in a third state in which the second section 226 of the cutout 202 receives a portion of the header 112 such that the header 112 is fixed to the shower door assembly 100 in at least the height (H) direction. For example, in this state, a topmost section of the header 112 can at least partially engage or contact the first surface 204 of the cutout 202, a side section of the header 112 can at least partially engage or contact the second surface 206 of the cutout 202, and a bottommost section of the header 112 can at least partially engage or contact the third surface 208 of the cutout 202. The entire width 220 (FIG. 2) of the header 112 can be disposed underneath the first surface 204 within the second section 226 (FIG. 2) of the cutout 202 such that the remainder of the cutout 202 can receive a dropped-in piece of the wall 102 to fix the header 112 within the cutout 202.

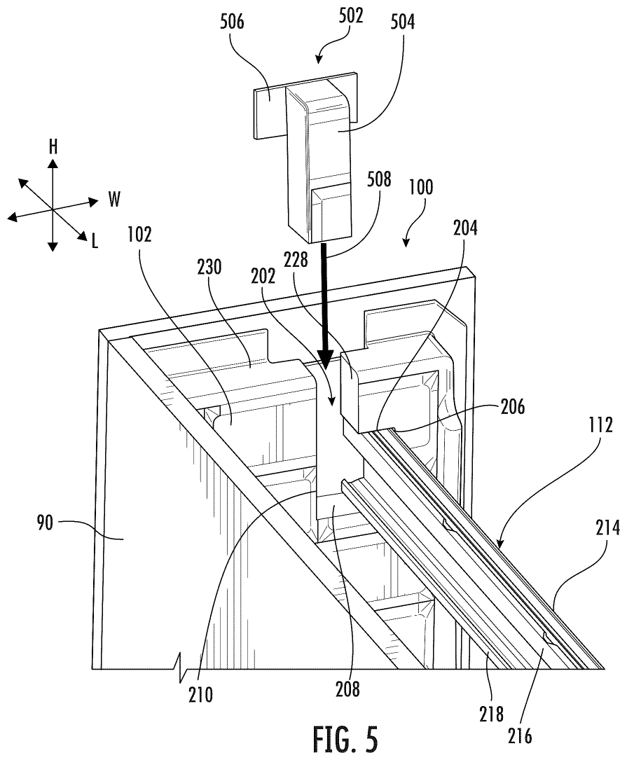

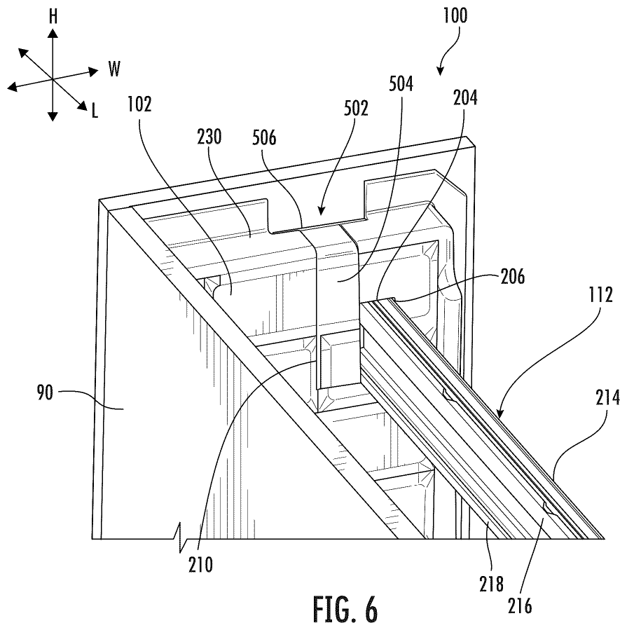

For example, FIG. 5 depicts a perspective view of the shower door assembly 100, according to an example embodiment, in a fourth state in which the cutout 202 (e.g., the first section 224) can receive a portion of a lock, such as a locking piece 502. The locking piece 502 may be a “drop-in” structure fitting at least partially in the cutout 202. The locking piece 502 may snap-fit within the cutout 202. The locking piece 502 can be formed of materials identical or similar to the wall 102. The locking piece 502 can include a first portion 504 that can extend substantially adjacent to the header 112. The first portion 504 can include a length (e.g., in the L direction) that substantially matches a length of the remainder of the shower wall 102. The locking piece 502 can include a second portion 506 that can extend substantially flush against the shower environment 90. The second portion 506 can facilitate preventing movement of the locking piece 502 when the locking piece 502 is in a desired position. For example, the second portion 506 of the locking piece 502 can tuck into or behind the wall 102 (e.g., along the shower environment 90 as depicted in FIG. 6) to prevent the locking piece 502 from moving in the L direction when the cutout 202 receives the locking piece 502. The second portion 506 can facilitate sealing (e.g., in a liquid-tight manner) the locking piece 502 with the shower wall 102. The first section 224 (FIG. 2) of the cutout 202 can receive the locking piece 502 such that the first portion 504 of the locking piece 502 at least partially contacts or engages the fourth surface 210 and the fifth surface 228 of the cutout 202 (e.g., the locking piece 502 can move in the direction of arrow 508).

FIG. 6 depicts a perspective view of the shower door assembly 100, according to an example embodiment, in a fifth state in which the cutout 202 (e.g., the first section 224) receives at least a portion of the drop-in locking piece 502 such that the header 112 is fixed to the shower door assembly 100 in at least the height (H) direction and the width (W) direction. As depicted in FIG. 6, the locking piece 502 can contact or engage the header 112 within the cutout 202 such that the header 112 is fixed in at least three directions.

The locking piece 502 can extend up to the edge 230 or topmost section of the shower wall 102 such that the locking piece 502 includes a section that is substantially planar with the edge 230 of the wall 102. The locking piece 502 can extend adjacent to the header 112 such that all sides of the header 112 can be enclosed in a manner in which a force applied to the header in either the height (H) or width (W) direction may not cause the header 112 to be displaced from the positioning within the second section 226 of the cutout 202. The third wall 106 can receive the header 112 via a cutout 202 in the third wall 106 at the same time the cutout 202 of the first wall 102 receives the header 112 to fix the header 112 relative to the shower system 98 in the length (L) direction.

The shower walls 102, 104, 106, and/or locking piece 502 can be formed in various ways. For example, the shower walls 102, 104, 106, and/or locking piece 502 can be formed via one or more molding processes (e.g., acrylic molding, fiberglass molding, marble molding, and/or various other molding techniques) such that the cutout 202 is molded or formed directly into the molded shower walls 102, 106. The locking piece 502 can be formed from at least some or all of the same materials and/or processes as the shower walls 102, 106 such that the molded locking piece 502 substantially matches a profile, color, shape, size, and/or other features of the shower wall 102, 104.

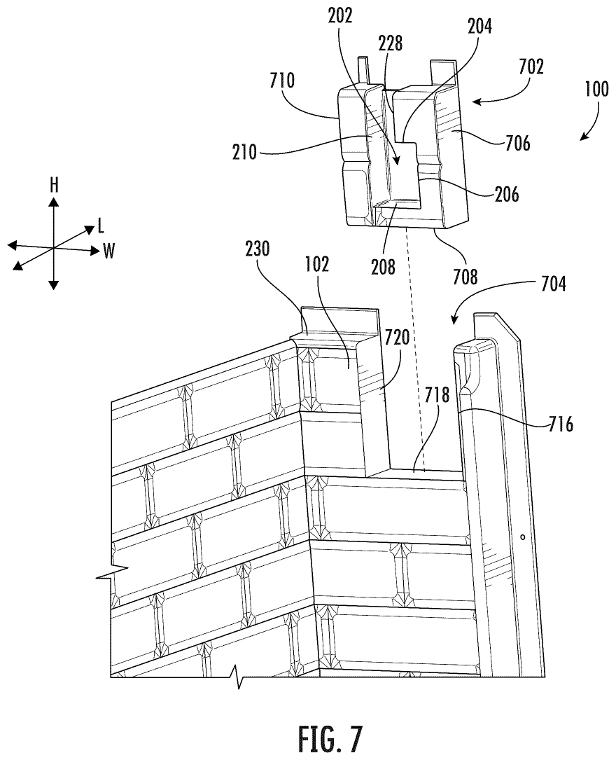

FIG. 7 depicts a perspective view of the shower door assembly 100, according to an example embodiment. In some embodiments, the shower door assembly 100 can include an interchangeable molded drop-in component 702 that defines or includes the cutout 202. For example, the component 702 can be or can include an injection molded piece configured to couple to a portion of the shower wall 102. For example, the shower wall 102 can include an opening 704 (e.g., defined by one or more of a first side 716, a second side 718, and a third side 720) that can at least partially or entirely receive the drop-in component 702 such that a first side 706, a second side 708, and a third side 710 of the component 702 engage with (e.g., contact) the first side 716, second side 718, and the third side 720 of the opening 704 formed in the shower wall 102. In some embodiments, the opening 704 and/or the interchangeable component 702 can be substantially rectangular or square in shape. In some embodiments, the opening 704 and/or the interchangeable component 702 can include various other shapes including, but not limited to, asymmetrical shapes.

The component 702 can couple to the shower wall 102 prior to or contemporaneously with the cutout 202 receiving the header 112 (e.g., the opening 704 can receive the component 702 prior to and/or at the same time that the cutout 202 receives a portion of the header 112). With this configuration, the shower door assembly 100 can accommodate cutouts 202 and/or headers 112 having various sizes or shapes while minimizing changes to the shower wall 102. For example, the shower wall 102 can include a standard sized or shaped opening 704 that can receive the interchangeable component 702 and the interchangeable component 702 can be easily modified through one or more molding processes (e.g., injection molding) to form cutouts 202 of different shapes or sizes. In other words, the shower door assembly 100 can be manufactured using one, uniform tool for the shower wall 102 and a smaller injection molded component 702 for accommodating variously sized and shaped headers 112 or other components configured to couple to the shower wall 102.

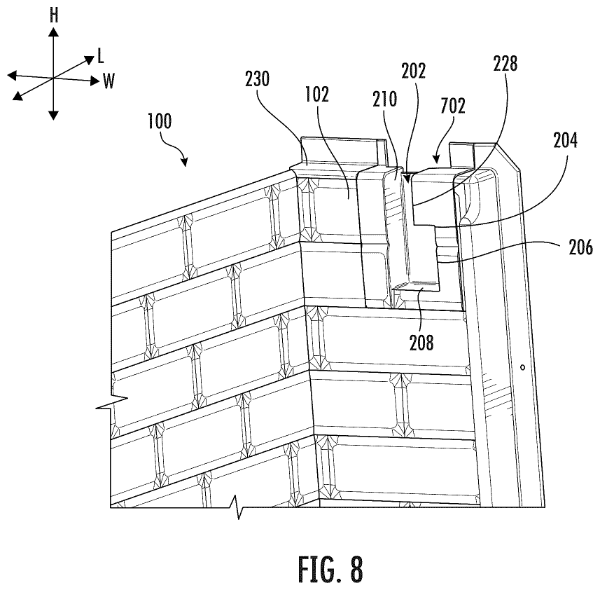

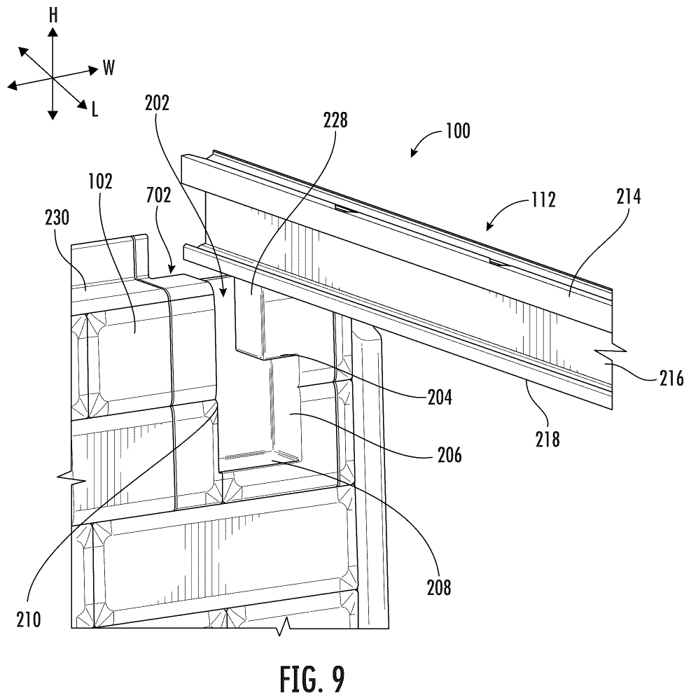

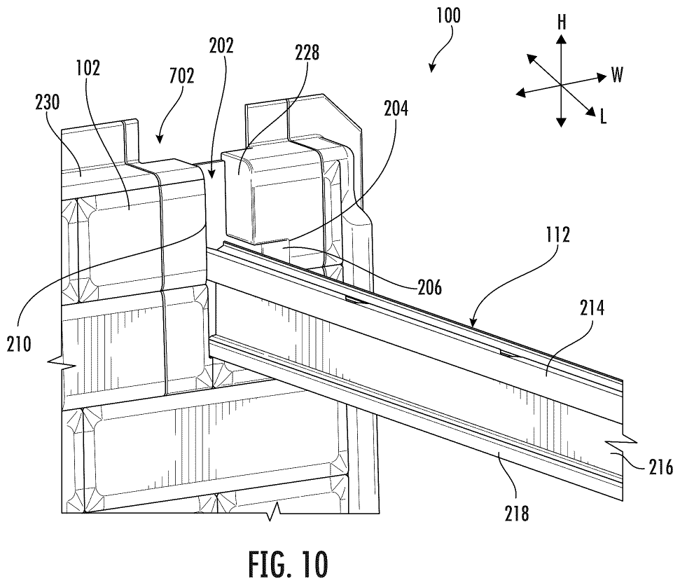

FIG. 8 depicts a perspective view of the shower door assembly 100 in a second state, according to an example embodiment. For example, FIG. 8 depicts the shower door assembly 100 in a state in which the opening 704 of the shower wall 102 receives the interchangeable molded component 702. FIG. 9 depicts a perspective view of the shower door assembly 100 in a third state, according to an example embodiment. For example, FIG. 9 depicts the shower door assembly 100 in a state in which the cutout 202 of the component 702 can receive a portion of the header 112. FIG. 10 depicts a perspective view of the shower door assembly 100 in a fourth state, according to an example embodiment. For example, FIG. 10 depicts the shower door assembly 100 in a state in which the cutout 202 of the component 702 receives the header 112.

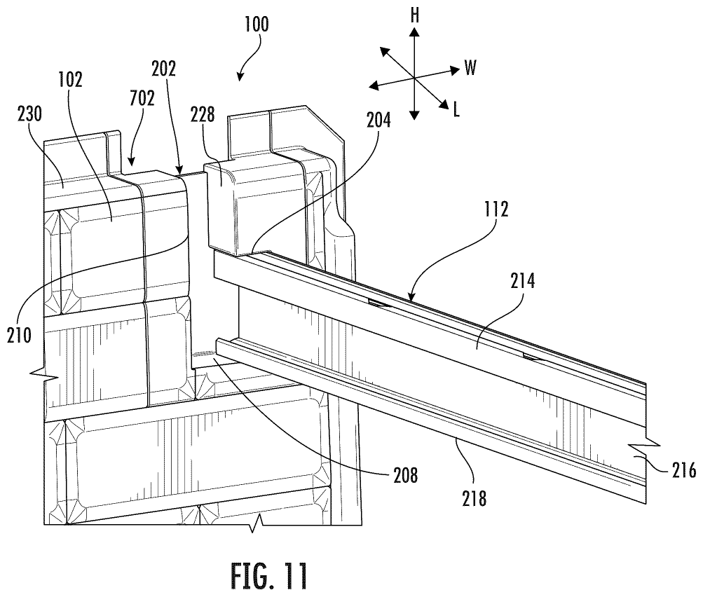

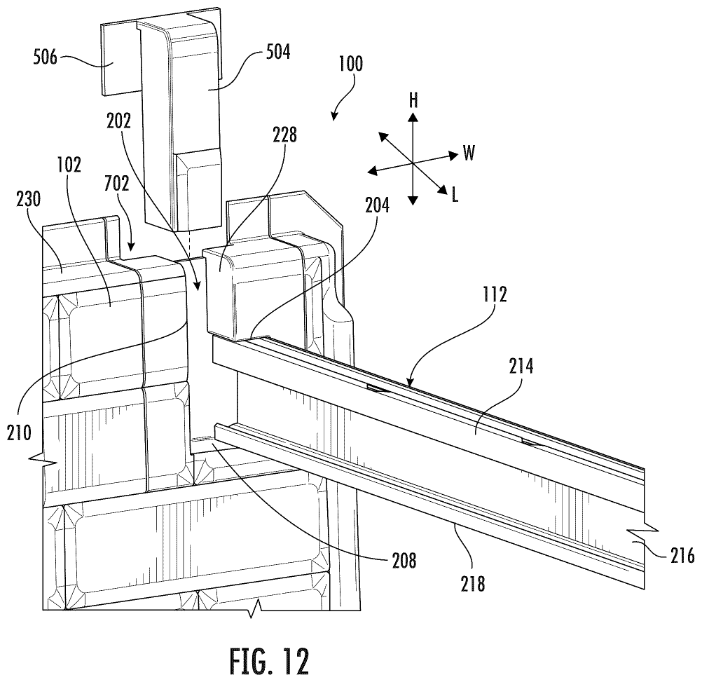

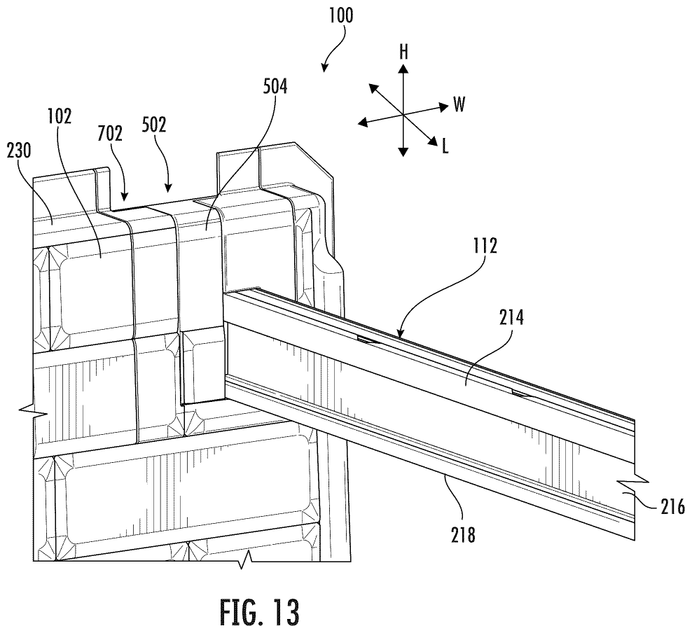

FIG. 11 depicts a perspective view of the shower door assembly 100, according to an example embodiment, in a fifth state in which the cutout 202 receives a portion of the header 112 such that the header 112 is fixed to the shower door assembly 100 in at least the height (H) direction, as described herein. FIG. 12 depicts a perspective view of the shower door assembly 100, according to an example embodiment, in a sixth state in which the cutout 202 (e.g., the first section 224) can receive a portion of the locking piece 502, as described herein. FIG. 13 depicts a perspective view of the shower door assembly 100, according to an example embodiment, in a seventh state in which the cutout 202 (e.g., the first section 224) receives at least a portion of the drop-in locking piece 502 such that the header 112 is fixed to the shower door assembly 100 in at least the height (H) direction and the width (W) direction, as described herein. The locking piece 502 and the interchangeable component 702 can be formed from at least some or all of the same materials and/or processes as the shower walls 102, 106 such that the molded locking piece 502 and the component 702 substantially matches a profile, color, shape, size, and/or other features of the shower wall 102, 104.

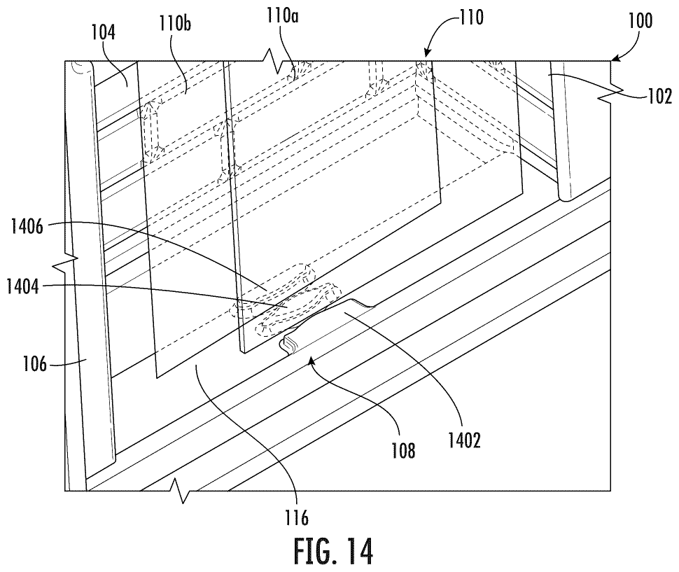

FIG. 14 depicts a perspective view of a portion of the shower system 98, according to an example embodiment. As described herein, the shower floor 116 can include at least one guide 108 to help with fluid containment and/or facilitate guiding the sliding of the door 110 relative to the shower floor 116. The guide(s) 108 can include an outer guide 1402, a middle guide 1404, and an inner guide 1406 disposed on the shower floor 116. The guides 108 can be configured such that the door 110 contacts or at least partially engages with at least two of the guides 1402, 1404, 1406 when sliding to facilitate the door 110 staying substantially in position in at least one direction (e.g., the length (L) direction) while sliding relative to the floor 116. For example, the door 110 can include two or more panels 110a, 110b coupled to the header 112 and slidable relative to the floor 116 and/or relative to one another. The outer guide 1402 and the middle guide 1404 can at least partially engage with a first panel 110a of the door 110 to facilitate keeping the first panel 110a moving in a substantially straight line relative to the floor 116. The middle guide 1404 and the inner guide 1406 can facilitate keeping a second panel 110b moving in a substantially straight line relative to the floor 116.

The shower floor 116 and/or guides 108 can be formed in various ways. For example, the shower floor 116 can be formed via molding such that the guides 108 (e.g., guides 1402, 1404, 1406) are molded into the floor 116. In other words, the guides 108 can be or can include molded inserts. The floor 116 and/or guides 108 can be formed in various other ways.

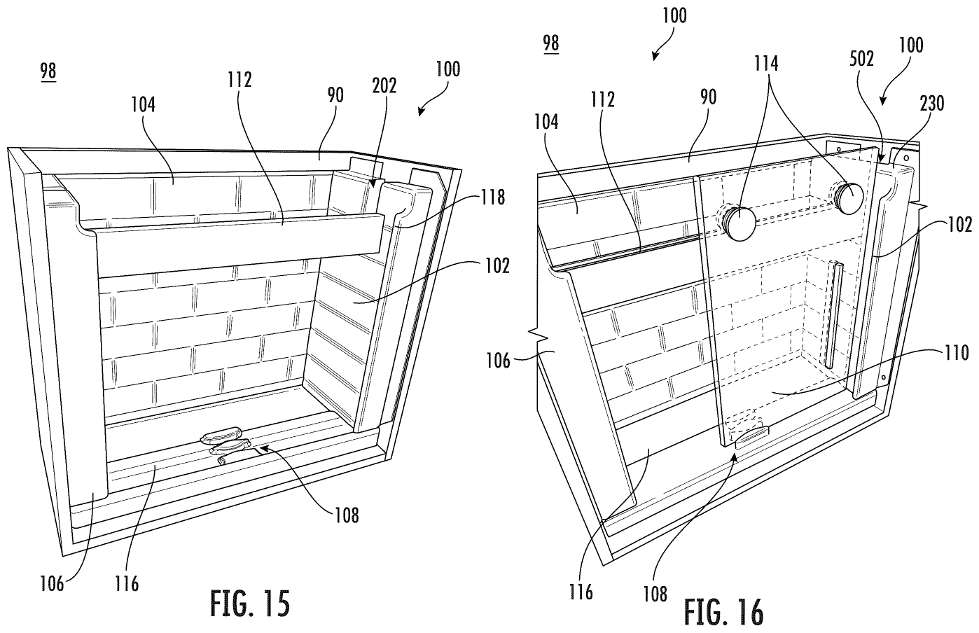

FIG. 15 depicts a perspective view of the shower system 98 having the header 112 within the cutout 202 (e.g., within the second section 226) with the door 110 and the locking piece 502 removed or decoupled, according to an example embodiment. FIG. 16 depicts a perspective view of the shower system 98 having the header 112 within the cutout 202 with the door 110 and the locking piece 502 coupled to the shower system 98, according to an example embodiment. As depicted in FIGS. 8 and 9, the locking piece 502 can be disposed within the cutout 202 such that the shower walls 102, 106 look substantially continuous when the locking piece 502 and header 112 is installed, even when the header 112 is disposed away from the edge 230 of the wall 102 (e.g., below the first surface 204 of the cutout 202 within the second section 226 as shown in the Figures and described herein).

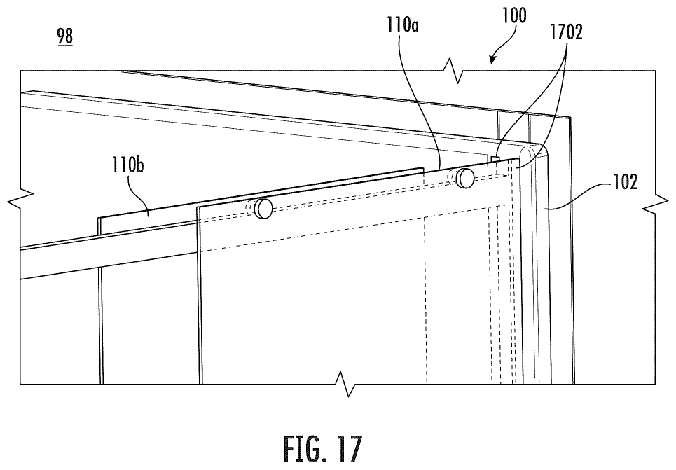

FIG. 17 depicts a perspective view of the shower system 98, according to an example embodiment. The shower system 98 can include at least one notch 1702 in at least one of the walls 102, 106 of the shower system 98. For example, the shower system 98 can include at least two notches 1702 in one or more walls 102, 106 of the shower system 98, as depicted in FIG. 17. The notches 1702 can be configured to receive a portion of the door 110. For example, a first notch 1702 can receive a portion of the first panel 110a of the door 110 and a second notch 1702 can receive a portion of the second panel 110b of the door 110. The one or more notches 1702 can allow the door panels to extend into the wall 102 to facilitate supporting the door 110 and enhancing water containment within the shower system 98.

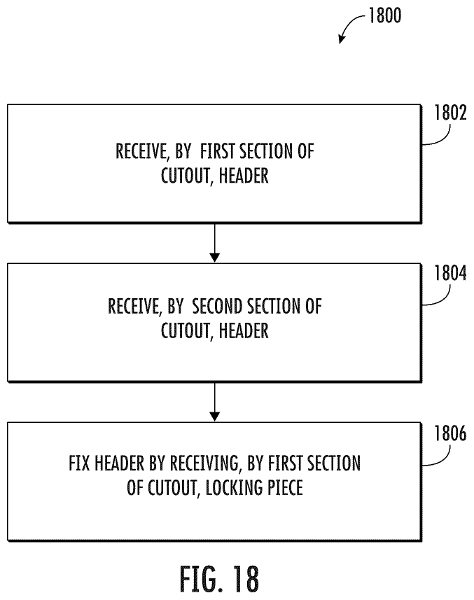

FIG. 18 is an illustration of a method 1800 of installing the shower door assembly 100, according to an example embodiment. The method 1800 can include receiving, by the first section 224 of the cutout 202 of the first shower wall 102 and/or the component 702, a portion of the header 112, as depicted in step 1802. For example, as depicted in at least FIGS. 2 and 3, the first section 224 of the cutout 202 can receive the header 112 such that at least a portion of the header 112 contacts the third surface 208 and/or the fourth surface 210 of the cutout 202 and may be positioned away from the second surface 206 of the cutout 202.

The method 1800 can include receiving, by the second section 226 of the cutout 202, a portion of the header 112 responsive to the header 112 moving in a direction (e.g., the direction of the arrow 302 in FIG. 3), as depicted in step 1804. For example, as depicted in at least FIGS. 2-4, the second section 226 of the cutout 202 can receive the header 112 such that at least a portion of the header 112 contacts the first surface 204, the second surface 206, and/or the third surface 208 of the cutout 202 and may be positioned away from the fourth surface 210 of the cutout 202.

The method 1800 can include fixing the header 112 in the second section 226 of the cutout 202 by receiving, by the first section 224 of the cutout 202, the locking piece 502, as depicted in step 1806. For example, as depicted in at least FIGS. 2, 5, and 6, the first section 224 of the cutout 202 can receive the locking piece 502 such that at least a portion of the locking piece 502 contacts the third surface 208, the fourth surface 210, and/or the header 112 and may be positioned away from the second surface 206 of the cutout 202. The locking piece 502 can be disposed adjacent to the header 112 such that the locking piece 502 fixes the header 112 within the second section 226 of the cutout 202 of the wall 102 in at least two directions (e.g., in all directions).

Advantageously, the shower door assembly 100 allows for easy installation of the shower door 110 and header 112 to one or more shower walls 102, 106 without the use of brackets. Additionally, the positioning of the second section 226 of the cutout 202 (e.g., underneath the first surface 204 of the cutout 202 and away from the edge 230 of the wall 102), the locking piece 502, and/or the guide(s) 108 on the floor 116 facilitate reducing undesirable displacement of the header 112 and/or door 110 during operation.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like, as used herein, mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The construction and arrangement of the elements of the assembly as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements, the position of elements may be reversed or otherwise varied, and the nature or number of discrete elements or positions may be altered or varied.

Additionally, the word “exemplary” is used to mean serving as an example, instance, or illustration. Any embodiment or design described herein as “exemplary” is not necessarily to be construed as preferred or advantageous over other embodiments or designs (and such term is not intended to connote that such embodiments are necessarily extraordinary or superlative examples). Rather, use of the word “exemplary” is intended to present concepts in a concrete manner. Accordingly, all such modifications are intended to be included within the scope of the present disclosure. Other substitutions, modifications, changes, and omissions may be made in the design, operating conditions, and arrangement of the preferred and other exemplary embodiments without departing from the scope of the appended claims.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Other substitutions, modifications, changes and omissions may also be made in the design, operating conditions and arrangement of the various exemplary embodiments without departing from the scope of the present invention. For example, any element disclosed in one embodiment may be incorporated or utilized with any other embodiment disclosed herein. Also, for example, the order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes and omissions may be made in the design, operating configuration, and arrangement of the preferred and other exemplary embodiments without departing from the scope of the appended claims.

What is claimed is:

1. A shower system, comprising:
a door;
a header configured to support the door such that the door can move relative to the header;
a shower wall having a cutout configured to receive a portion of the header;
a drop-in locking piece configured to be disposed in the cutout to fix the portion of the header to the shower wall; and
a shower floor having at least two guides configured to guide movement of the door relative to the shower floor and the header.

2. The shower system of claim 1, wherein the cutout comprises:
an opening at an edge of the shower wall;
a first section that extends in a height direction from the opening to a first surface; and
a second section that extends in a width direction from the first section to a second surface;
wherein the opening is configured to receive the portion of the header such that the header engages the first surface in a first state; and
wherein the second section is configured to receive the portion of the header such that the header engages the first surface and the second surface in a second state.

3. The shower system of claim 2, wherein:
the first surface extends along the width direction, the second surface extends along the height direction, and the cutout includes a third surface that extends along the width direction and opposes at least a portion of the first surface; and
the second section is configured to restrict movement of the portion of the header in at least one direction by at least a portion of the first surface, the second surface, and the third surface.

4. The shower system of claim 2, wherein the drop-in locking piece is configured to fix the portion of the header within the second section to restrict movement of the portion of the header in at least two directions.

5. The shower system of claim 1, further comprising:
an interchangeable molded component configured to removably couple to the shower wall by an opening of the shower wall; and
wherein the interchangeable molded component includes the cutout.

6. The shower system of claim 1, wherein the drop-in locking piece is configured to match a profile of the shower wall with the drop-in locking piece disposed in the cutout.

7. The shower system of claim 1, wherein the at least two guides are molded inserts of the shower floor.

8. A method of installing a shower door assembly, comprising:
receiving, by a first section of a cutout of a shower wall, a portion of a header, the header configured to support a door;
receiving, by a second section of the cutout, the portion of the header responsive to the header moving in a first direction; and
fixing the portion of the header in the second section of the cutout by receiving, by the first section of the cutout, a locking piece;
wherein the first section of the cutout is disposed adjacent to the second section of the cutout.

9. The method of claim 8, wherein:
the first section of the cutout extends from an opening at an edge of the shower wall to a first surface in a height direction;
the second section of the cutout extends in a width direction from the first section to a second surface; and
fixing the portion of the header in the second section of the cutout further comprises restricting, by the second section of the cutout, movement of the header in at least one direction.

10. The method of claim 9, wherein fixing the portion of the header by the locking piece comprises restricting, by the locking piece and the second surface of the second section, movement of the header in at least two directions.

11. The method of claim 8, further comprising:
receiving, by an opening of the shower wall, an interchangeable molded component, wherein the interchangeable molded component includes the cutout; and
wherein the interchangeable molded component is configured to match a profile of the shower wall.

12. The method of claim 8, wherein the locking piece is configured to match a profile of the shower wall when the cutout receives the locking piece.

13. The method of claim 8, further comprising:
receiving, by a first guide and a second guide of a shower floor, a portion of the door; and
guiding, by the first guide and the second guide, movement of the door in a first direction;
wherein the first guide and the second guide include molded inserts formed with the shower floor.

14. A shower door assembly, comprising:
a header configured to support a door;
a shower wall having a cutout configured to receive a portion of the header; and
a drop-in locking piece configured to be disposed in the cutout to fix the portion of the header to the shower wall.

15. The shower door assembly of claim 14, wherein the cutout comprises:
an opening at an edge of the shower wall;
a first section that extends in a height direction from the opening to a first surface; and
a second section that extends in a width direction from the first section to a second surface;
wherein the opening is configured to receive the portion of the header such that the header engages the first surface in a first state; and
wherein the second section is configured to receive the portion of the header such that the header engages the first surface and the second surface in a second state.

16. The shower door assembly of claim 15, wherein:
the first surface extends along the width direction, the second surface extends along the height direction, and the cutout includes a third surface that extends along the width direction and opposes at least a portion of the first surface; and
the second section is configured to restrict movement of the portion of the header in at least one direction by at least a portion of the first surface, the second surface, and the third surface.

17. The shower door assembly of claim 15, wherein the drop-in locking piece is configured to fix the portion of the header within the second section to restrict movement of the portion of the header in at least two directions.

18. The shower door assembly of claim 14, further comprising:
an interchangeable molded component configured to removably couple to the shower wall by an opening of the shower wall; and
wherein the interchangeable molded component includes the cutout.

19. The shower door assembly of claim 14, wherein the shower wall comprises a molded wall having the cutout.

20. The shower door assembly of claim 14, wherein the drop-in locking piece comprises a molded piece that substantially matches a profile of the shower wall.
